(19) United States
(12) Patent Application Publication
(10) Pub. No.: US 2022/0333585 A1
(43) Pub. Date: Oct. 20, 2022

(54) MOBILE PUMP SYSTEM PROVIDED WITH COUPLED MOTOR DRIVE FOR PUMPING WATER AND METHOD THEREFOR

(71) Applicant: HYTRANS BEHEER B.V., LEMMER (NL)

(72) Inventors: Robert Dirk HUT, LEMMER (NL); Appie VEENEMA, LEMMER (NL)

(73) Assignee: HYTRANS BEHEER B.V., LEMMER (NL)

(21) Appl. No.: 17/762,650

(22) PCT Filed: Sep. 9, 2020
(86) PCT No.: PCT/NL2020/050555

§ 371 Date: Mar. 22, 2022

(30) Foreign Application Priority Data
Sep. 24, 2019 (NL) 2023887

(51) Int. Cl. F04B 17/00; F04B 23/04; F04B 53/08; F04B 53/16; A62C 25/00

(52) U.S. Cl. CPC F04B 17/00; F04B 23/04; F04B 53/08; F04B 53/16; A62C 25/00

(57) ABSTRACT

The invention relates to a mobile pump system for pumping water and/or extinguishing agent and an associated method therefor. The mobile pump system comprises:

a frame for housing the pump system;

a booster pump arranged in the frame;

one or more submersible pumps arranged in the frame;

a booster pump motor drive configured to drive the booster pump;

a hydraulics motor drive configured to drive the one or more submersible pumps and wherein the hydraulics motor drive is configured to function as auxiliary drive for the booster pump; and

a coupling for coupling the booster pump to the hydraulics motor drive such that the hydraulics motor drive can function as auxiliary drive for the booster pump.

The present invention relates to a mobile pump system for pumping water and/or an extinguishing agent, wherein the pump system is provided with a motor drive. Such mobile pump systems are for instance utilized in the case of fires at industrial complexes, in buildings, nature areas, and in the case of flooding.

Mobile pump systems for pumping water which are known in practice make use of a frame provided with a so-called booster pump to be able to thereby displace water (for extinguishing) over relatively great distances. The pump system frame is further provided with a submersible pump operatively connected thereto. A motor drive is used to drive the booster pump. A separate motor drive is used for the submersible pump.

A problem with such mobile pump systems is that they are utilized in practice at locations that are usually remote and difficult to reach. This means that a mobile pump system of the stand-alone type is required. Conventional pump systems therefore make use here of heavy drives, which are usually over-dimensioned. This makes such mobile pump systems inefficient and expensive to use and purchase, and they are thereby frequently used at a less than optimal operating point, which additionally results in usually relatively high emissions.

The present invention has for its object to provide an improved mobile pump system for pumping water and/or an extinguishing agent, whereby the above stated drawbacks are obviated or at least reduced, such that a source of fire and/or a flood can be combatted more effectively.

This object is achieved with a mobile pump system for pumping water and/or an extinguishing agent according to the invention, the mobile pump system comprising:
a frame for housing the pump system;
a booster pump arranged in the frame;
one or more submersible pumps arranged in the frame;
a booster pump motor drive configured to drive the booster pump;
a hydraulics motor drive configured to drive the one or more submersible pumps and wherein the hydraulics motor drive is further configured to function as an auxiliary drive for the booster pump; and
a coupling for coupling the booster pump to the hydraulics motor drive such that the hydraulics motor drive can function as auxiliary drive for the booster pump.

The extinguishing agent is particularly water for extinguishing which is optionally provided with one or more additives, such as a foaming agent. The frame is particularly a housing, preferably in the form of a container, which is displaceable. Such a displacement is possible with a vehicle suitable for this purpose. It is likewise even possible to integrate the frame with a vehicle and/or to provide it with a drive for displacement. The booster pump is suitable for displacing the water and/or extinguishing agent over relatively great distances. It is hereby for instance possible to supply water for extinguishing from a ditch, lake or other water supply and to combat a fire. The frame is further provided with at least one submersible pump arranged therein for the purpose of pumping up the water for extinguishing and/or pumping up flood water.

A booster pump motor drive is configured to drive the booster pump. According to the invention, a separate hydraulics motor drive is configured to drive the one or more submersible pumps. It is hereby achieved at the booster pump and the one or more submersible pumps can be driven separately, preferably at their own desired and most suitable operating point. Emissions are hereby limited to a minimum.

According to the invention, a coupling is further provided for the purpose of coupling the booster pump to the hydraulics motor drive, such that the hydraulics motor drive can function as auxiliary drive for the booster pump. Such a coupling is for instance embodied as a reverse clutch. The hydraulics motor drive can hereby be activated in effective manner. It will be apparent that other couplings are also possible. Coupling the hydraulics motor drive to the booster pump motor drive makes it possible to provide the booster pump with extra power and to thereby displace for instance water and/or extinguishing agent over a greater distance. A flexible drive is hereby provided, wherein the power can be tuned to the actual requirement in effective manner

In a currently preferred embodiment the booster pump and hydraulics motor drives are embodied substantially the same in respect of motor power, among other things. Smaller motor drives can thereby suffice than in the conventional motor drive for such a booster pump. This makes purchasing and maintenance of such drives more efficient. This therefore increases the options for the utility of a mobile pump system according to the invention. In addition, more available motor drives hereby qualify for use. This increases flexibility in designing the mobile pump system according to the present invention.

The mobile pump system is preferably operatively connected to a reel set and/or provided therewith in order to thereby make the pump system usable in even more effective manner. The reel sets are preferably used for the hydraulic drive. It is particularly the effect of the so-called stand-alone mobile pump system according to the invention that is hereby enhanced.

In an advantageous embodiment according to the invention the coupling is provided with a hydraulic drive driveable by the hydraulics motor drive.

By providing a hydraulic drive the hydraulics motor drive is used indirectly to function as auxiliary drive for the booster pump. The coupling or activation of the hydraulics motor drive is hereby simplified, if necessary. Such a coupling can additionally be implemented during operation and without noticeable shocks or disruptions. This increases the operational reliability of the pump system according to the invention.

In an advantageous embodiment according to the invention a controller is further provided for the purpose of controlling the booster pump and hydraulics motor drive.

By providing such a controller the management and control of the mobile pump system according to the invention can be increased further. It is here possible, among other things, to switch over at suitable moments and for instance activate the hydraulics motor drive automatically or semi-automatically in order to supply extra power for the booster pump. This make it possible to utilize the drives as optimally as possible at the most suitable operating point. This also reduces the operating costs of the pump system according to the invention as well as emissions, or at least considerably reduces the cost thereof. In a preferred embodiment the pump system is further provided with one or more sensors connected to said controller for controlling the booster pump and hydraulics motor drives. Examples of such sensors are for instance a pressure gauge and a flow meter. With such sensors it is possible to provide an autonomous or semi-autonomous system. A central control for all or at least most components of the mobile pump system is preferably enabled. This is particularly advantageous for those mobile pump systems according to the invention that are used relatively infrequently so that users, for instance operators, have limited experience with the pump system. This makes the pump system according to the invention relatively simple to operate, which results in a more operationally reliable application, inter alia in emergency situations.

In an advantageous preferred embodiment according to the invention the mobile pump system further comprises a control panel for operating and/or setting the pump system. Providing a control panel further simplifies the operation for an operator. The effect already stated above of an operationally reliable application is hereby realized, also in situations where the mobile pump system according to the invention is used infrequently and operators therefore have little experience.

In a currently preferred embodiment the control panel is provided on the outer side of the frame. Providing the control panel on the outer side increases the convenience of use. It is also prevented that noise emission is increased in that the mobile pump system is not arranged in a closed frame and an operator must enter the housing in order to control the system. In a preferred embodiment according to the invention the frame is provided with a container-type housing, preferably provided with insulated walls, whereby noise emission is reduced still further. By providing the control panel on the outer side this noise restriction is also maintained during use.

In an advantageous embodiment according to the invention the booster pump motor drive is provided with a water cooling.

By providing the booster pump drive with a water cooling an effective and efficient cooling can be brought about for this drive. The water cooling preferably makes use here of pumped-up water for extinguishing. The hydraulics motor drive is preferably provided with a radiator cooling. Optimal cooling is achieved hereby, also for this hydraulics motor drive. The radiator cooling for the hydraulics motor drive is preferably combined with the water cooling for the booster pump motor drive so as to provide a cooling for the whole motor drive for the mobile pump system according to the invention. In the currently preferred embodiment of the invention the hydraulics motor drive with hydraulic pumps is started. This is provided with a radiator cooling. As soon as water has been carried through the submersible pumps to the booster pump, the booster pump (diesel) motor drive of the booster pump is started. This preferably takes place automatically. The booster pump motor drive for the booster pump is then preferably cooled by water for extinguishing. This results in a compact system and produces a further noise reduction.

In a further advantageous preferred embodiment according to the invention the mobile pump system further comprises a metering pump or foam pump.

By providing a metering pump or foam pump an additive, such as a foaming agent, can be added to the water for extinguishing so as to thereby further increase the utility of the mobile pump system.

The metering pump or foam pump is preferably provided with a displaceable metering pump frame so as to thereby further increase the flexibility for the utility of the metering pump or foam pump.

In a further advantageous embodiment according to the invention the one or more submersible pumps are provided with a displaceable submersible pump frame.

Providing a displaceable submersible pump frame enables the one or more submersible pumps to be displaced to the desired location in effective manner

The invention further relates to a method for pumping water and/or extinguishing agent, the method comprising the steps of:
providing a mobile pump system in an embodiment according to the invention as described above;
placing the mobile pump system;
activating the mobile pump system; and
pumping water for extinguishing and/or excess water.

The method provides similar advantages and effects as described for the mobile pump system.

In an advantageous embodiment the method further comprises of activating the hydraulics motor drive as auxiliary drive for driving the booster pump through a hydraulic driving of the coupling. An effective driving is hereby achieved.

In a further advantageous embodiment the method comprises of autonomously controlling the mobile pump system. This is particularly advantageous in mobile pump systems which are only utilized to limited extent, for instance exclusively in emergency situations, as already described above for the mobile pump system.

Further advantages, features and details of the invention are elucidated on the basis of preferred embodiments thereof, wherein reference is made to the accompanying drawings, in which:

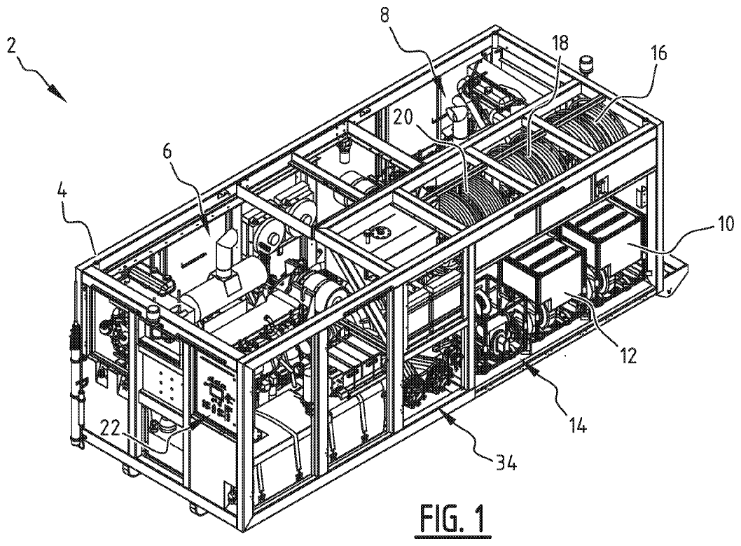

FIG. 1 is a view of a mobile pump system according to the invention;

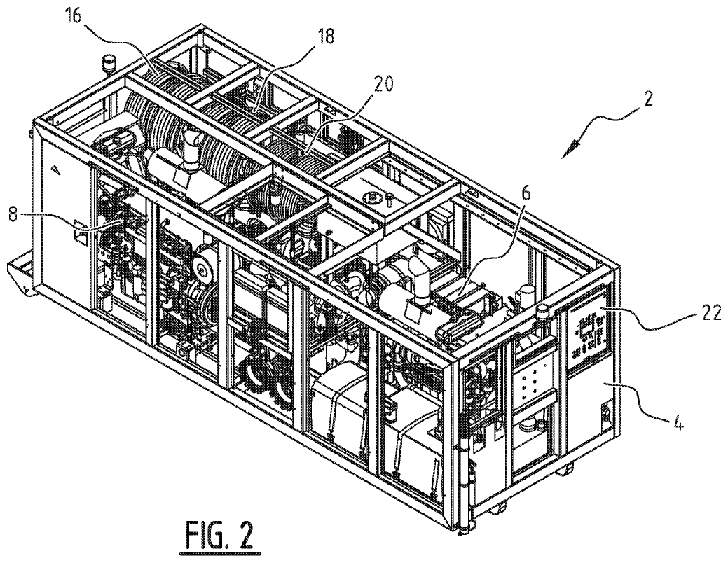

FIG. 2 is a further view of the pump system of FIG. 1;

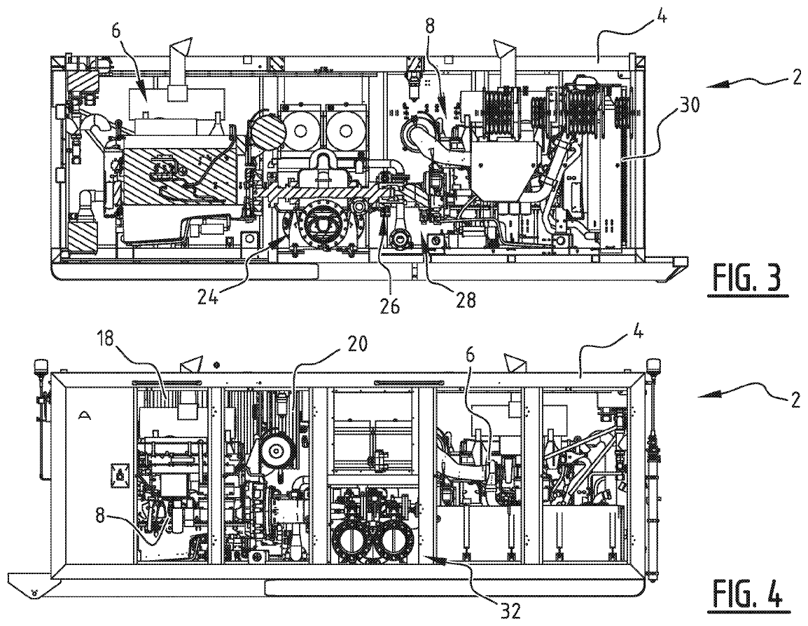

FIG. 3 is a cross-section of the pump system of FIG. 1;

FIG. 4 is a side view of the pump system according to FIG. 1;

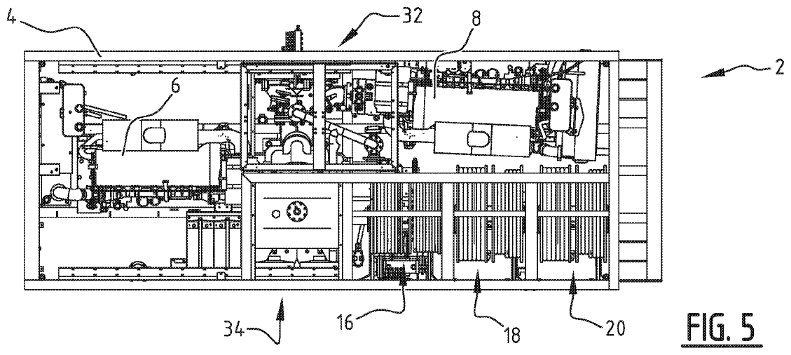

FIG. 5 is a top view of pump system 1;

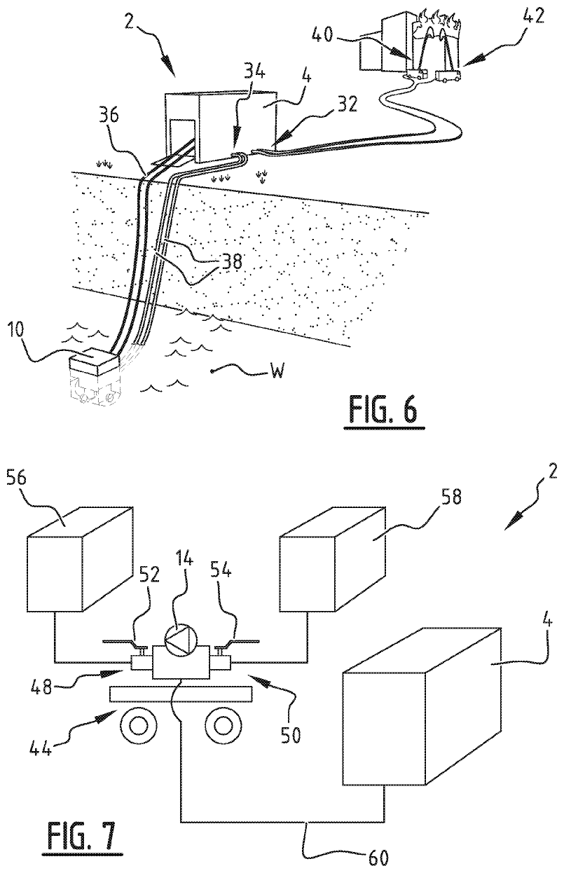

FIG. 6 is a view of the pump system in a situation of use while combating a source of fire; and

FIG. 7 is a view of the pump system in a situation of use with the addition of an additive.

Mobile pump system 2 (FIGS. 1 and 2) is provided with container 4 as a frame in which booster pump (diesel) motor drive 6 is arranged for the purpose of pumping the water. Also arranged in container 4 is hydraulics motor drive 8 for other components, including submersible pumps 10, 12, metering pump or foam pump 14, booster pump 24 and ventilation. In the shown embodiment mobile pump system 2 is further provided with two hydraulic submersible pumps 10, 12 for supplying water. A removable foam pump 14 is also arranged. Submersible pumps 10, 12 and foam pump 14 are provided with respective reel sets 16, 18 and 20. Control panel 22 is further arranged on the outer side of container 4.

In a currently preferred embodiment the user opts to start drive 6, after which hydraulics drive 8 is started at a desired moment by controlling control panel 22.

Booster pump motor drive 6 (FIG. 3) is used to drive booster pump 24. In the shown embodiment coupling 26 is operatively connected to hydraulic drive 28, which is powered by hydraulics motor drive 8. Hydraulics motor drive 8 is provided with radiator 30 for cooling.

Outlet 32 (FIGS. 4, 5) of pump system 2 is preferably operatively connected to an extinguishing conduit or discharge. Inlet/feed 34 (FIGS. 1, 5) is further operatively connected during use to a feed conduit for supply of, among other things, water for extinguishing.

During use (FIG. 6) pump system 2 with container 4 is placed close to waterway W or another water supply. Conduits 36 then run between container 4 and submersible pump 10 which is placed in water W. Extinguishing conduits 38 form a connection via inlet/feed 34 and outlet 32 in/on container 4 to spray nozzles 40, 42 for the purpose of combating a source of fire.

In a possible application mobile pump system 2 with container 4 is utilized to combat for instance (oil well) fires. Foam can here be applied as extinguishing agent. Applied for this purpose is foam pump 14 with displaceable frame 44 and provided with a double coupling 46 with connections 48, 50 which are provided with shut-off valves/(ball) valves 52,54 (FIG. 7). Foam pump 14 can hereby be connected to containers/IBCs 56, 58 for the purpose of supplying foaming agent. Foaming agent is hereby transported further from containers 56, 58 and conduits 60 in the direction of container 4, and there added to for instance the water for extinguishing in order to realize the desired foaming.

In the case of an emergency situation, such as a fire or flood, mobile pump system 2 is placed close to a waterway W. One or more submersible pumps 10, 12 are placed in waterway W. Foam pump 14 is optionally placed close to the foaming agent which is for instance supplied in containers 56, 58. Owing to the double coupling 46 to valves 52, 54, switching from an almost empty container to a new container is greatly simplified without interfering with the combating of the emergency situation. When starting up the operation, the user preferably switches on hydraulics drive 8. Booster pump motor drive 6 is preferably started automatically by the controller of the control panel. Drives 6, 8 are hereby utilized at the most optimal operating point possible. A user can optionally also control booster pump and/or hydraulics motor drives 6, 8 manually.

In a currently preferred embodiment use is made of two substantially identical 588 kW motor drives, wherein hydraulics motor drive 8 can be utilized partially for inter alia hydraulic submersion pumps 10, 12 and partially for booster pump 24. In a comparative test mobile pump system 2 was compared to a conventional pump system provided with an 800 kW booster pump and a 240 kW hydraulic submersible pump. In this conventional system use is made here of a motor drive for the booster pump made suitable specifically therefor. The comparison shows that emission is considerably greater in such conventional systems as compared to pump system 2 according to the invention, or the costs are at least considerably higher. It has been found that in mobile pump system 2 according to the invention two drives 6,8, which are preferably provided with the same power, bring about a significant reduction in emissions. This is the case for both exhaust emission and noise emission. It has been found that such a preferred embodiment results in wide utility, lower costs and greatly reduced exhaust emission and noise emission.

The present invention is by no means limited to the above described preferred embodiments thereof. The rights sought are defined by the following claims, within the scope of which many modifications can be envisaged.

1-14. (canceled)

15. A mobile pump system for pumping water and/or extinguishing agent, comprising:
a frame for housing the pump system;
a booster pump arranged in the frame;
one or more submersible pumps arranged in the frame;
a booster pump motor drive configured to drive the booster pump;
a hydraulics motor drive configured to drive the one or more submersible pumps, wherein the hydraulics motor drive is configured to function as auxiliary drive for the booster pump; and
a coupling for coupling the booster pump to the hydraulics motor drive such that the hydraulics motor drive can function as auxiliary drive for the booster pump.

16. The mobile pump system according to claim 15, wherein the coupling comprises a hydraulic drive driveable by the hydraulics motor drive.

17. The mobile pump system according to claim 15, further comprising a controller for controlling the booster pump and the hydraulics motor drive.

18. The mobile pump system according to claim 17, wherein the pump system is provided with one or more sensors operatively connected to the controller for controlling the booster pump and hydraulics motor drive.

19. The mobile pump system according to claim 15, further comprising a control panel for operating and/or setting the pump system.

20. The mobile pump system according to claim 19, wherein the control panel is provided on an outer side of the frame.

21. The mobile pump system according to claim 15, wherein the booster pump motor drive is provided with a water cooling.

22. The mobile pump system according to claim 15, wherein the hydraulics motor drive is provided with a radiator cooling.

23. The mobile pump system according to claim 15, further comprising a metering pump.

24. The mobile pump system according to claim 23, wherein the metering pump is provided with a displaceable metering pump frame.

25. The mobile pump system according to claim 15, wherein the one or more submersible pumps are provided with a displaceable submersible pump frame.

26. A method for pumping water for extinguishing and/or excess water, comprising the steps of:
providing a mobile pump system for pumping water and/or extinguishing agent, comprising:
a frame for housing the pump system;
a booster pump arranged in the frame;
one or more submersible pumps arranged in the frame;
a booster pump motor drive configured to drive the booster pump;
a hydraulics motor drive configured to drive the one or more submersible pumps and wherein the hydraulics motor drive is configured to function as auxiliary drive for the booster pump; and
a coupling for coupling the booster pump to the hydraulics motor drive such that the hydraulics motor drive can function as auxiliary drive for the booster pump;
placing the mobile pump system;
activating the mobile pump system; and
pumping water for extinguishing and/or excess water.

27. The method according to claim 26, further comprising activating the hydraulics motor drive as an auxiliary drive for driving the booster pump through a hydraulic driving of the coupling.

28. The method according to claim 26, further comprising of autonomously controlling the mobile pump system.

29. The method according to claim 27, further comprising of autonomously controlling the mobile pump system.

30. The mobile pump system according to claim 16, further comprising a controller for controlling the booster pump and the hydraulics motor drive.

31. The mobile pump system according to claim 30, wherein the pump system is provided with one or more sensors operatively connected to the controller for controlling the booster pump and hydraulics motor drive.

32. A mobile pump system for pumping water and/or extinguishing agent, comprising:
a frame for housing the pump system;
a booster pump arranged in the frame;
one or more submersible pumps arranged in the frame;
a booster pump motor drive configured to drive the booster pump;
a hydraulics motor drive configured to drive the one or more submersible pumps, wherein the hydraulics motor drive is configured to function as auxiliary drive for the booster pump;
a coupling for coupling the booster pump to the hydraulics motor drive such that the hydraulics motor drive can function as auxiliary drive for the booster pump;
a controller for controlling the booster pump and hydraulics motor drive; and
a control panel for operating and/or setting the pump system.

33. The mobile pump system according to claim 32, wherein the pump system is provided with one or more sensors operatively connected to the controller for controlling the booster pump and hydraulics motor drive.

34. The mobile pump system according to claim 33, wherein the one or more submersible pumps are provided with a displaceable submersible pump frame.
